(19) United States
(12) Patent Application Publication
(10) Pub. No.: US 2010/0165799 A1
(43) Pub. Date: Jul. 1, 2010

(54) Watch Winder with a Sensing Switch

(76) Inventor: Wen-Hsin HUANG, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/344,237

(22) Filed: Dec. 25, 2008

(51) Int. Cl. G04B 9/00

(52) U.S. Cl. 368/210

(57) ABSTRACT

A watch winder with a sensing switch comprises a housing, a driving member, a rotary watch mount, a light sensor, an adjustable counting device and a main board. The housing is divided by a mid clapboard into a display space and an assembly space. The drive member has a rotary shaft and is disposed in the assembly space, and the rotary shaft is inserted through the mid clapboard into the display space. The rotary watch mount has a fixing portion fixed to the rotary shaft of the drive member and a lightproof portion. The light sensor is disposed on the mid clapboard to sense the lightproof portion. The adjustable counting device is disposed on the mid clapboard and its value is manually adjustable. The main board is disposed in the assembly space of the housing and electrically connected with the drive member, the light sensor and the adjustable counting device.

### BACKGROUND OF THE INVENTION

1. Field of the Invention

The present invention relates to a watch winder, and more particularly to a watch winder with a sensing switch.

2. Description of the Prior Art

Normally, a mechanical or automatic watch will stop running when it is not worn for a certain period of time, and a long time of not working will even impair the mechanical performance of the watch. However, these problems can be easily solved by a watch winder.

Referring to FIG. 1, which is a perspective of a conventional watch winder, wherein a driving member (not shown) is disposed on the front panel 12 of the winder housing 11 for driving a rotary watch mount 13 to rotate. On the bottom of the rotary watch mount 13 is a fixing portion 131 having a protrusion 132 employed to touch a micro switch 14. With each revolution the rotary watch mount 13 rotates, the protrusion 132 will touch the micro switch 14 one time. Setting the number of times of touching the micro switch 14 can automatically stop the rotary watch mount 13, making the mechanical or automatic watch wind up automatically, so that all collected or displayed mechanical or automatic watches can be kept in an optical working condition, and have greater accuracy accordingly. However, this conventional watch winder:

As shown in FIG. 2, using the protrusion 132 of the rotary watch mount 13 to contact the micro switch 14 can make the rotary watch mount 13 stop automatically after rotating a predetermined number of revolutions. However, since the protrusion 132 will touch the press portion 141 of the switch 14 one time with each revolution the rotary watch mount 13 rotates, the frequent and direct touch will causing abrasion of the protrusion 132 or damage the micro switch 14, and as the abrasion accumulates, the watch winder will finally lose function.

The present invention has arisen to mitigate and/or obviate the afore-described disadvantages.

### SUMMARY OF THE INVENTION

The primary objective of the present invention is to provide a watch winder with a sensing switch which works in a noncontact induction manner so as to prevent the watch winder from abrasion even after a long period of use.

A watch winder with a sensing switch in accordance with the present invention comprises: a housing in which being disposed a mid clapboard for dividing the housing into a display space and an assembly space; a drive member with a rotary shaft being disposed in the assembly space of the housing in such a manner that the rotary shaft is inserted through the mid clapboard and partially into the display space; a rotary watch mount for mounting a watch having a fixing portion formed at a bottom thereof, and a lightproof portion adjacent to the fixing portion, the fixing portion being fixed to the rotary shaft of the drive member; a light sensor disposed on the mid clapboard and serving to sense the lightproof portion of the rotary watch mount; an adjustable counting device disposed on the mid clapboard of the housing and its value being manually adjustable; and a main board disposed in the assembly space of the housing and electrically connected with the drive member, the light sensor and the adjustable counting device.

### BRIEF DESCRIPTION OF THE DRAWINGS

FIG. 1 is a perspective view of a conventional watch winder;

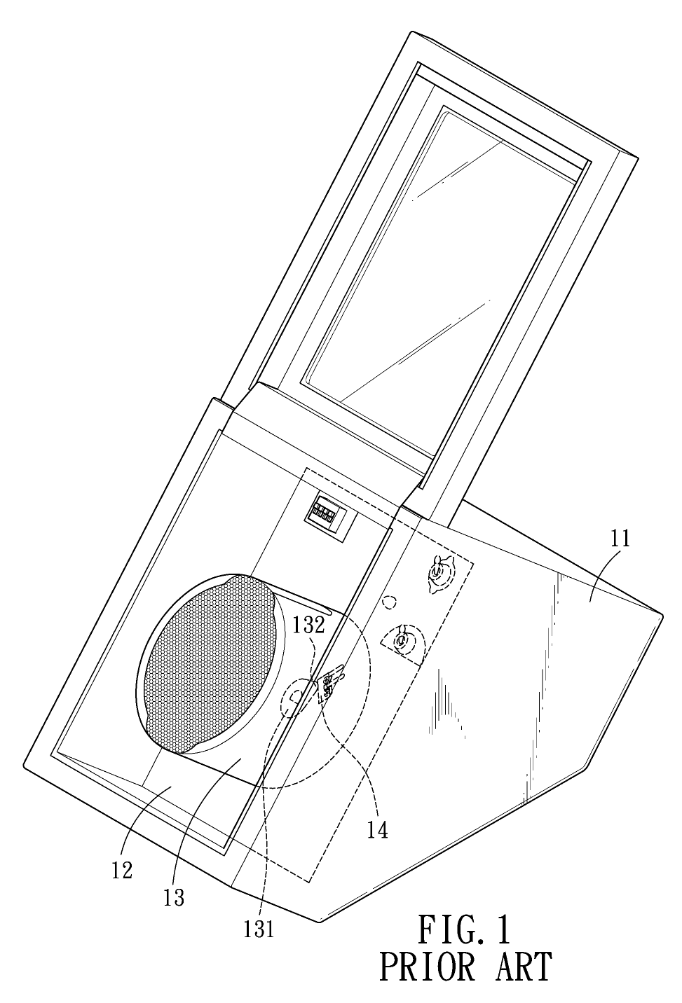

FIG. 2 is a magnified view showing a rotary watch mount and a micro switch of the conventional watch winder;

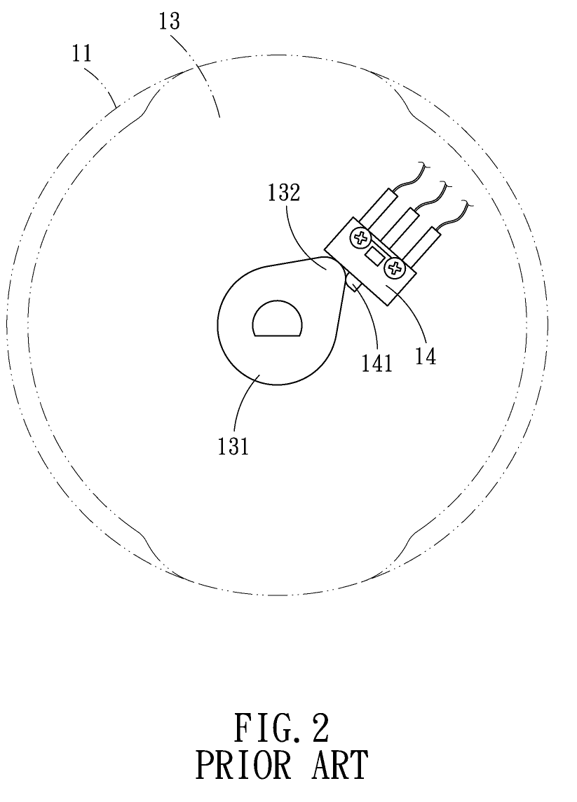

FIG. 3 is a perspective view of a watch winder in accordance with a first embodiment of the present invention;

FIG. 4 is a front view of the watch winder in accordance with the first embodiment of the present invention;

FIG. 5 is a side view of the watch winder in accordance with the first embodiment of the present invention;

FIG. 6 is a magnified view showing a rotary watch mount and a micro switch of the watch winder in accordance with the first embodiment of the present invention; and

FIG. 7 is a side view of a watch winder in accordance with a second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

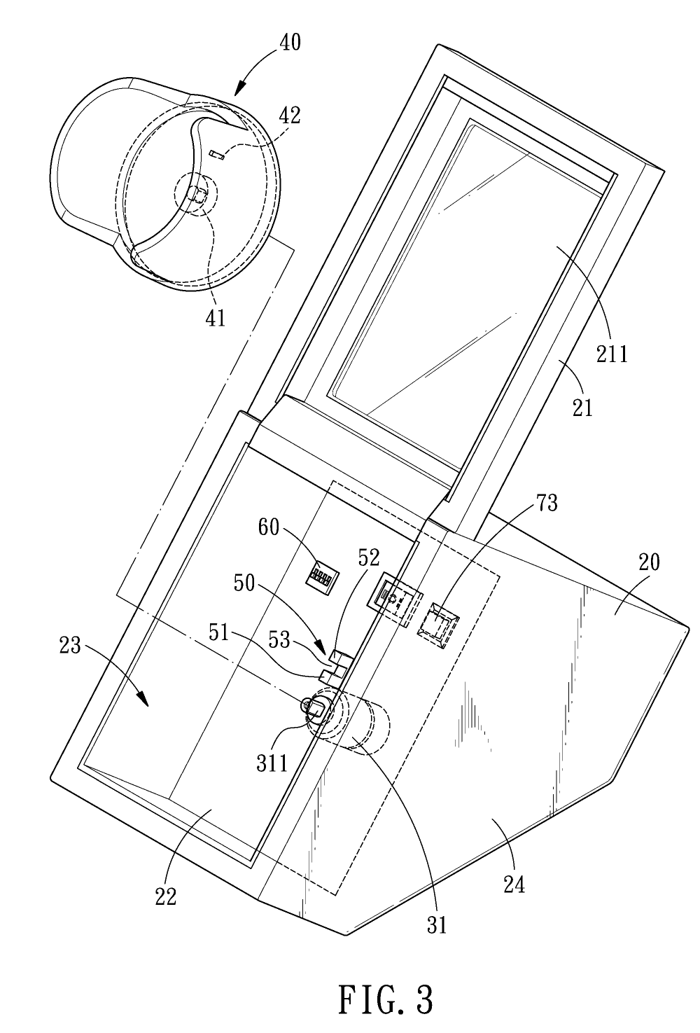

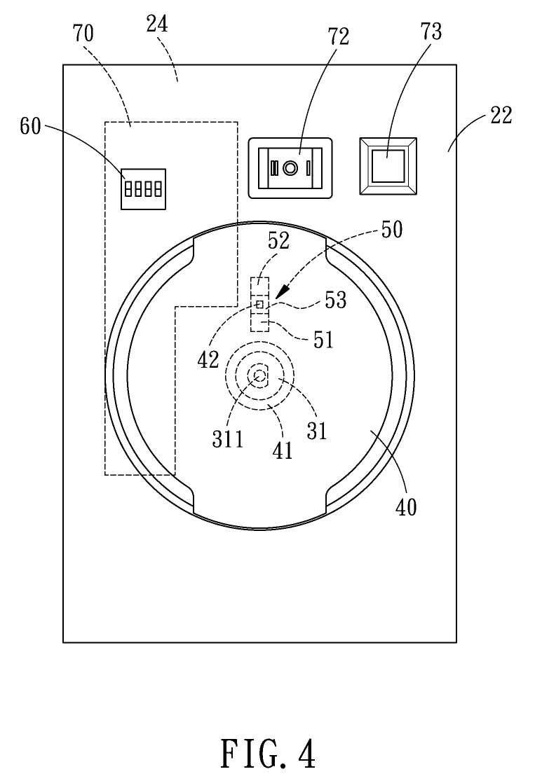

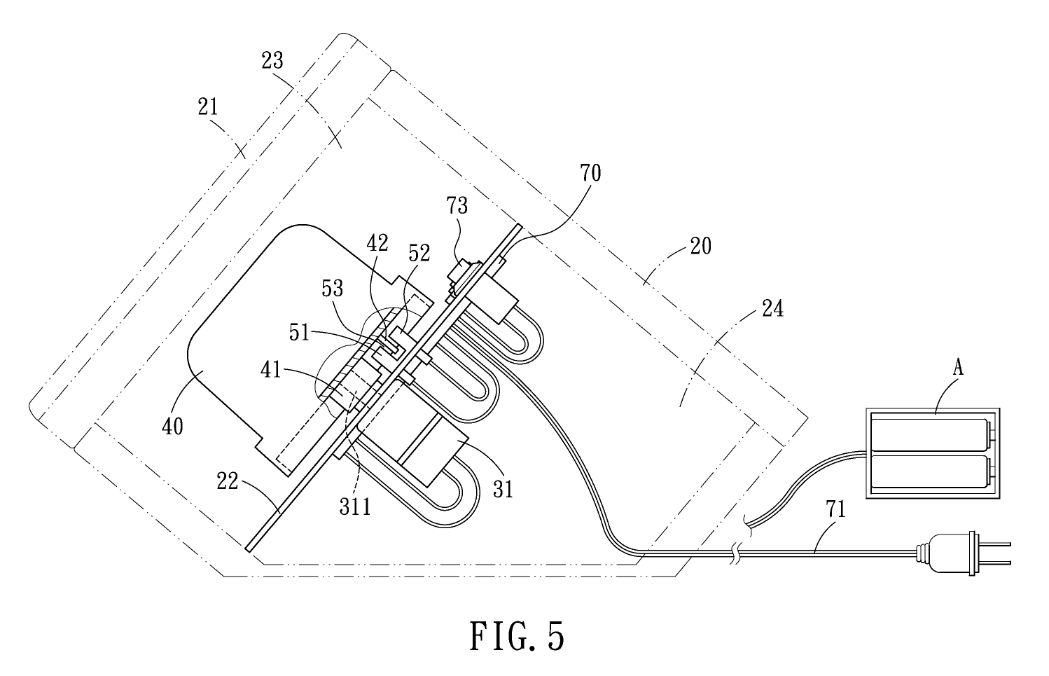

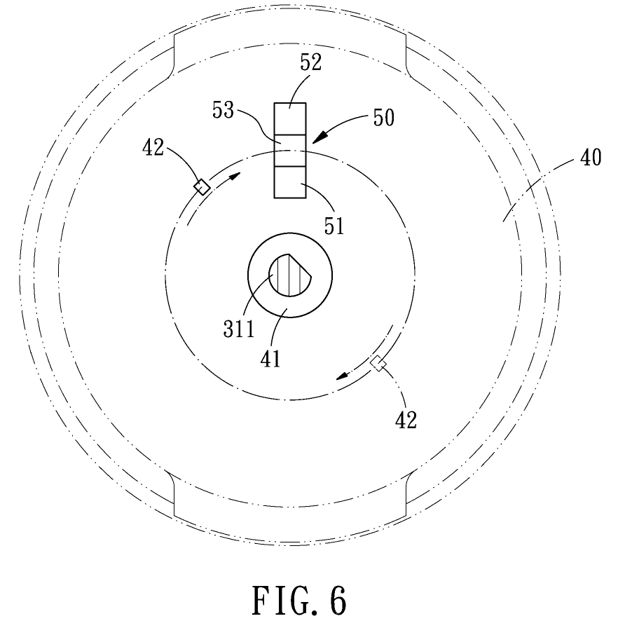

Referring to FIGS. 3-6, a watch winder in accordance with the present invention comprises: a housing 20, a driving member, a rotary watch mount 40, a light sensor 50, an adjustable counting device 60 and a main board 70.

The housing 20 is a hollow box pivotally covered with a cover 21 having a transparent window 211. In the housing 20 is disposed a mid clapboard 22 which defines a display space 23 with respect to the transparent window 211 and an assembly space 24 with respect to the inner surface of the housing 20.

The driving member is a motor 31 which comprises a rotary shaft 311 and is disposed in the assembly space 24 of the housing 20 in such a manner that the rotary shaft 311 is pivotally inserted through the mid clapboard 22 and partially into the display space 23.

The rotary watch mount 40 is provided for mounting the watch and has a fixing portion 41 at the center of the bottom thereof, and adjacent to the fixing portion 41 is a lightproof portion 42. The fixing portion 41 is fixed to the rotary shaft 311 of the motor 31 to enable the rotary watch mount 40 to be located in the display space 23 of the housing 20 and rotated by the motor 31.

The light sensor 50 includes a light emitter 51 and a light receiver 52 that are disposed on the mid clapboard 22 and spaced a distance 53 which allows for the passage of the lightproof portion 42 of the rotary watch mount 40, so that the action of interrupting the light transmission between the light emitter 51 and the light receiver 52 by using the lightproof portion 42 can enable the light sensor 50 to obtain a control signal.

The adjustable counting device 60 is disposed on the mid clapboard 22 of the housing 20 and its count setting (value) can be manually adjusted.

The main board 70 is disposed in the assembly space 24 of the housing 20 and electrically connected with the motor 31, the light sensor 50 and the adjustable counting device 60 and is also connected to a power source which can be a battery type power supply system A or a power socket (not shown) by a power cable 71. The main board 70 is further electrically connected with a rotation speed controller 72 and a switch 73. The rotation speed controller 72 is mounted on the mid clapboard 22 of the housing 20 and serves to control the rotation speed of the rotary shaft 311 of the motor 31 via the main board 70. The switch 73 is disposed on the mid clapboard 22 of the housing 20 and employed to stop or start the motor 31.

The structural arrangement of the first embodiment of the present invention has been explained as above, and for a better understanding of the present invention, its operation and function, reference should be made further to FIGS. 3, 5 and 6.

After the user sets the value of the adjustable counting device 60, the switch 73 will make the motor 31 drive the rotary watch mount 40 to rotate. During rotation, the lightproof portion 42 of the rotary watch mount 40 will move through the distance 53 between the light emitter 51 and the light receiver 52 and interrupt the light transmission therebetween, and accordingly the light sensor 50 will obtain a control signal and transmits it to the main board 70. Once receiving the control signal, the main board 70 will compare it with the value set in the adjustable counting device 60, and if matched, will stop the motor 31, making the mechanical or automatic watch wind up automatically, so that all collected or displayed mechanical or automatic watches on the rotary watch mount 40 can be kept in an optical working condition.

The present invention utilizes the motion of the lightproof portion 42 of the rotary watch mount 40 between the light emitter 51 and the light receiver 52 to make the rotary watch mount 40 stop automatically after rotating a predetermined number of revolutions. During rotation, the lightproof portion 42 of the rotary watch mount 40 doesn't contact the light emitter 51 and the light receiver 52, and this is a noncontact type induction control method. Hence, the watch winder of the present invention can be prevented from abrasion even after a long period of use.

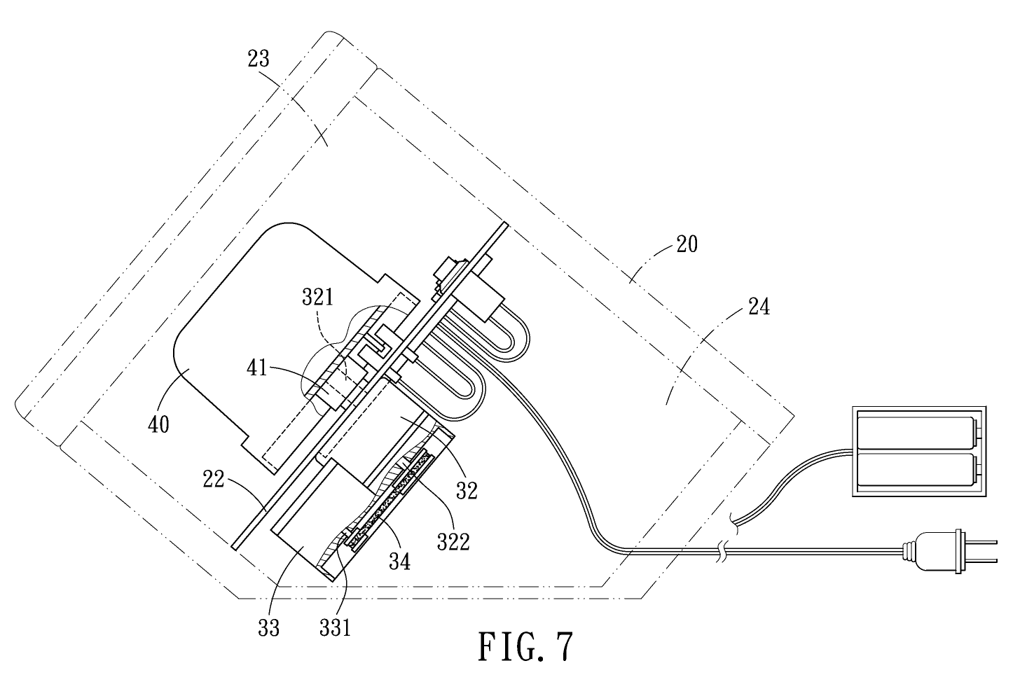

A watch winder of a second embodiment of the present invention is shown in FIG. 7, which is the same as the first embodiment except that:

The drive member includes a reduction mechanism 32 and a motor 33. The reduction mechanism 32 includes a rotary shaft 321 and a driven shaft 322 which are dynamically connected to each other. The motor 33 includes a driving shaft 331. The reduction mechanism 32 is disposed in the assembly space 24 of the housing 20 in such a manner that the rotary shaft 321 is pivotally inserted through the mid clapboard 22 and partially into the display space 23. The part of the rotary shaft 321 located in the display space 23 is jointed to the fixing portion 41 for driving the rotary watch mount 40 to rotate. The driven shaft 322 of the reduction mechanism 32 is dynamically connected to the driving shaft 331 of the motor 33 by a belt 34, enabling the rotary watch mount 40 to rotate at a lower speed and larger torque than the motor 33.

While we have shown and described various embodiments in accordance with the present invention, it is clear to those skilled in the art that further embodiments may be made without departing from the scope of the present invention.

What is claimed is:

1. A watch winder with a sensing switch comprising:
a housing in which being disposed a mid clapboard for dividing the housing into a display space and an assembly space;
a drive member with a rotary shaft being disposed in the assembly space of the housing in such a manner that the rotary shaft is inserted through the mid clapboard and partially into the display space;
a rotary watch mount for mounting a watch having a fixing portion formed at a bottom thereof, and a lightproof portion adjacent to the fixing portion, the fixing portion being fixed to the rotary shaft of the drive member;
a light sensor disposed on the mid clapboard and serving to sense the lightproof portion of the rotary watch mount;
an adjustable counting device disposed on the mid clapboard of the housing and its value being manually adjustable; and
a main board disposed in the assembly space of the housing and electrically connected with the drive member, the light sensor and the adjustable counting device.

2. The watch winder with a sensing switch as claimed in claim 1, wherein a rotation speed controller is disposed on the mid clapboard and electrically connected with the main board, so as to control the rotation speed of the rotary shaft of the drive member via the main board.

3. The watch winder with a sensing switch as claimed in claim 2, wherein a switch is disposed on the mid clapboard and electrically connected with the main board, so as to stop and start the drive member via the main board.

4. The watch winder with a sensing switch as claimed in claim 3, wherein the housing is pivotally covered with a cover having a transparent window.

5. The watch winder with a sensing switch as claimed in claim 1, wherein the drive member includes a reduction mechanism and a motor, the reduction mechanism has a rotary shaft for driving the rotary watch mount to rotate and has a driven shaft dynamically connected with a driving shaft of the motor.

6. The watch winder with a sensing switch as claimed in claim 5, wherein the driven shaft of the reduction mechanism is dynamically connected to the driving shaft of the motor by a belt.

7. The watch winder with a sensing switch as claimed in claim 6, wherein a rotation speed controller is disposed on the mid clapboard and electrically connected with the main board, so as to control the rotation speed of the rotary shaft of the drive member via the main board.

8. The watch winder with a sensing switch as claimed in claim 7, wherein a switch is disposed on the mid clapboard and electrically connected with the main board, so as to stop and start the drive member via the main board.

9. The watch winder with a sensing switch as claimed in claim 8, wherein the housing is pivotally covered with a cover having a transparent window.
